(19) United States
(12) Patent Application Publication
(10) Pub. No.: US 2006/0245344 A1
(43) Pub. Date: Nov. 2, 2006

(54) Apparatus and method for defect management of optical disks

(76) Inventor: Fong Hua Song, Tucheng City (TW)

Correspondence Address: Raymond Sun;Attorney for Applicant, 12420 Woodhall Way, Tustin, CA, 92782, US

(21) Appl. No.: 11/403,524

(22) Filed: Apr. 13, 2006

(30) Foreign Application Priority Data
Apr. 14, 2005 (TW) 094111773

(51) Int. Cl. G11B 7/24

(52) U.S. Cl. 369/275.4

(57) ABSTRACT

An apparatus and method for defect management of optical disks is disclosed. The apparatus can use existing pre-pit data on the disk to perform defect management, thereby upgrading defect detection efficiency and data access reliability. The apparatus reads the pre-pit data corresponding to a data block from the disk, and performs ECC decoding thereon. Next, the apparatus determines if the pre-pit data is defective according to the decoding result, thereby deciding whether to access the data block subsequently.

### BACKGROUND OF INVENTION

1. Field of the Invention

The present invention relates to the field of optical storage, and more particularly, to an apparatus and method for defect management of optical disks.

2. Description of the Prior Art

In general, defects of recordable optical disks (including write-once and rewritable disks) occur because: (1) unsatisfactory manufacturing process of the disk; (2) improper usage such that the disk is scraped; and (3) material degradation after frequent access. The defect would lower down the storage performance of the disk. Thus, it is a critical problem about how to perform effective defect management for the optical disk.

By performing defect management, the defects of the disk are detected and recorded. Then, an optical drive can use the record to bypass the defective portion when accessing the disk.

In conventional defect management, before writing data onto a recordable disk, the optical drive first writes predetermined patterns onto the disk and then reads them back, thereby determining whether there is any defective sector on the disk. If any defective sector is found, the logical sector number (LSN) of the defective sector is recoded in a defect list for subsequent use. FIGS. 1A and 1B are diagrams showing the structure for performing defect management. In FIG. 1A, an optical drive 1a includes a defect list 14 for recording the LSNs of defective sectors of a disk 15. When a host 2a is to access the disk 15, the LSN of the sector to be accessed is provided to the optical drive 1a via an interface 11, and is translated into a physical sector number (PSN) by a sector number converting unit 12. Then, an access control unit 13 accesses the disk 15 according to the PSN. During the above process, the defective sector on the disk 15 is bypassed by checking the defect list 14. In FIG. 1A, defect management is performed by the optical drive 1a. Besides, in FIG. 1A (and also FIG. 1B), the dotted arrows represent the transmission of sector numbers, while the real arrows represent the transmission of user data.

On the other hand, the defect list 14 lies in a host 2b in FIG. 1B. When the host 2b is to access the disk 15, the host 2b first checks the defect list 14 so as to bypass the defective sector, and then provides the LSN of the sector to be accessed to an optical drive 1b. The remaining operation is similar to the structure of FIG. 1A. That is, in FIG. 1B, defect management is performed by the file system of the host 2b.

However, no matter FIG. 1A or 1B, several drawbacks exist: (1) the conventional structures of FIGS. 1A and 1B can be applied to rewritable disks but not to write-once disks since pre-writing of patterns is required for defect detection; (2) the defect detection process is time consuming since including the above write-then-read process; and (3) the write-then-read process during defect detection may cause the material degradation of the disk.

### SUMMARY OF INVENTION

It is therefore one objective of this invention to provide an apparatus and method for performing defect management of an optical disk by using existing pre-pit data on the optical disk, thereby upgrading the efficiency of defect detection.

Another objective of this invention is to provide an optical drive which applies the apparatus and method for defect management of an optical disk mentioned above, thereby upgrading the efficiency and reliability of the optical drive.

Another objective of this invention is to provide an apparatus and method for performing defect management of an optical disk, thereby saving the time for detection to upgrade the detection efficiency and access efficiency of an optical drive.

Another objective of this invention is to provide an apparatus and method for performing defect management of an optical disk. This apparatus and method can be applied to both write-once and rewritable disks.

### BRIEF DESCRIPTION OF THE DRAWINGS

For further understanding the objects, the characteristics, and the functions of the structures of the present invention, a detailed description matched with corresponding drawings are presented as follows.

FIGS. 1A and 1B are diagrams showing the conventional structure for performing defect management.

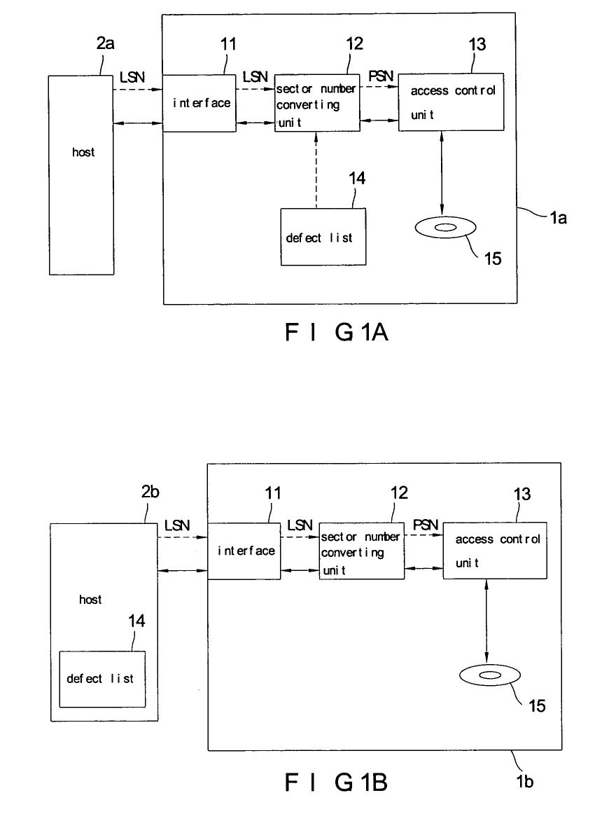

FIG. 2 is a diagram showing the physical structure of the DVD-R/RW disk in micro view.

FIG. 3 is a diagram showing the pre-pit block structure of the DVD-R/RW disk.

FIG. 4 is a block diagram of a preferred embodiment of the apparatus for defect management of an optical disk according to the present invention.

FIG. 5 is a flow chart of a preferred embodiment of the method for defect management of an optical disk according to the present invention.

### DETAILED DESCRIPTION

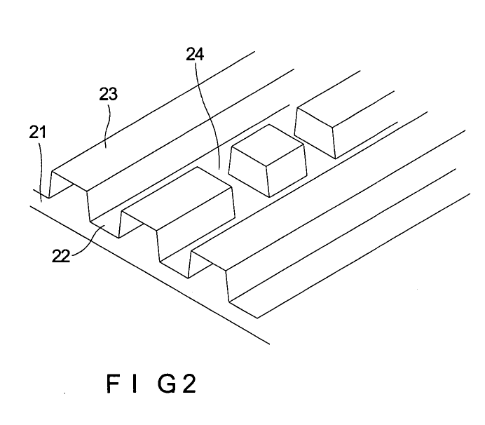

The embodiments described in this section can be applied to a DVD disk, such as DVD-R disk, DVD-RW disk, DVD+R disk, DVD+RW disk, DVD-RAM disk, or other type disk. Before describing the embodiments, an example of the DVD-R/RW disk is used to explain the pre-pit data thereon. According to the technical specification (standard ECMA-338), a DVD-R/RW disk contains a plurality of ECC blocks (called data block below) for storing data. Each data block has a corresponding pre-pit data. FIG. 2 is a diagram showing the physical structure of the DVD-R/RW disk in micro view. As shown in FIG. 2, the disk is separated into two portions of groove 22 and land 23 upon a substrate 21. The groove 22 forms the data block for a user to write onto. The land 23 is used to record pre-pit data 24, which is also called land pre-pit (LPP). The pre-pit data 24 is generated during the manufacturing process of the disk, and records the physical location (i.e. ECC block address) and related disk information of the corresponding data block.

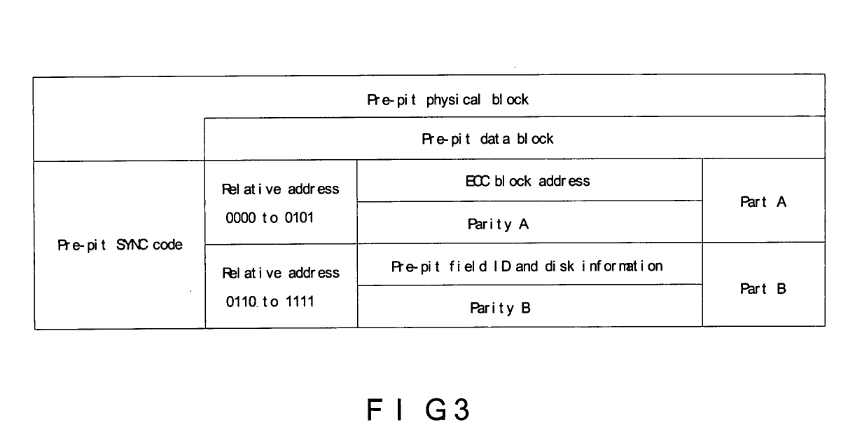

On a DVD-R/RW disk, the corresponding pre-pit data of each data block also forms a block, the structure of which is shown in FIG. 3. In FIG. 3, a pre-pit physical block is formed by a pre-pit data block adding the pre-pit SYNC code, and the pre-pit data block is composed of 16 pre-pit data frames, which are grouped into Part A (10 frames) and Part B (6 frames). Both Part A and Part B have a field of relative address for each pre-pit data frame to record a relative location of the corresponding frame within the whole pre-pit data block. In addition to the relative address, Part A further records an ECC block address of the corresponding data block recorded in the groove, and Part B further records a pre-pit field ID and disk information. Part A and Part B are respectively encoded with Reed-Solomon code (the relative address not included), and thus have a respective error correction code (called Parity A and Parity B respectively). As to Part A, the ECC block address and Parity A each contains three bytes, so the generated Reed-Solomon code is RS(6,3,4). As to Part B, the pre-pit field ID and the disk information total seven bytes, and Parity B contains three bytes. Thus, the generated Reed-Solomon code is RS(10,3,8). For other disk specifications, the pre-pit data is also structured in a similar manner as above, and the more detailed description can refer to the corresponding specification.

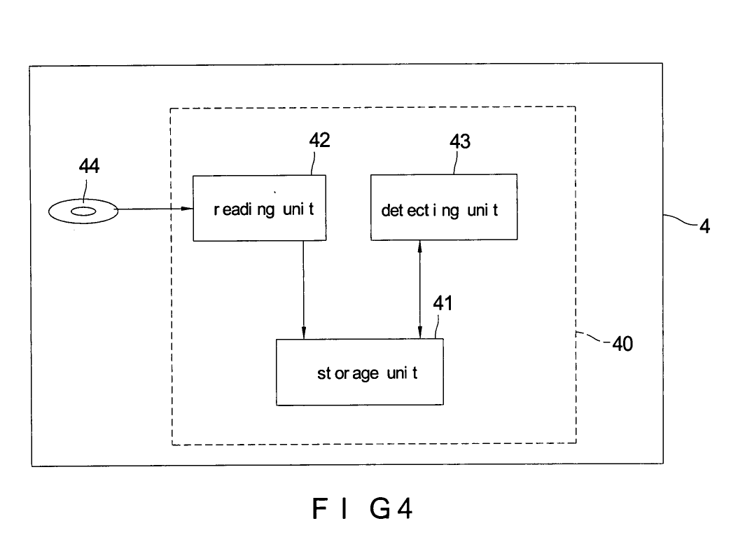

FIG. 4 is a block diagram of a preferred embodiment of the apparatus for defect management of an optical disk according to the present invention. The apparatus 40 in FIG. 4 is set in an optical drive 4, and detects and records defective pre-pit data of the disk. Then, the optical drive can bypass the data block corresponding to the defective pre-pit data when the optical drive accesses the disk. As shown in FIG. 4, the apparatus 40 comprises a storage unit 41, a reading unit 42, and a detecting unit 43. The reading unit 41 reads the pre-pit data corresponding to a data block from a disk 44, and stores the read data into the storage unit 41. The detecting unit 43, coupled to the storage unit 41, performs ECC decoding on the pre-pit data stored in the storage unit 41, and determines whether the pre-pit data is defective according to the result of the ECC decoding.

In one embodiment, the disk 44 is a DVD-R/RW disk. When performing the ECC decoding on the pre-pit data, the detecting unit 43 first generates a plurality of syndromes of Part A and Part B of the pre-pit data, and then determines whether the pre-pit data needs an error correction. When the syndromes of Part A and Part B are all zero, it means the pre-pit data contains no error. Thus, the detecting unit 43 determines that the pre-pit data needs no error correction and that the pre-pit data is non-defective.

On the other hand, when at least one of the syndromes of Part A and Part B is not zero, it means at least one of Part A and Part B contains at least one error. Then, the detecting unit 43 performs an error correction on Part A (or Part B), and determines whether the pre-pit data is defective according to the result of the error correction. According to the property of the Reed-Solomon code, the number of erasure errors e and the number of errors t of RS(n,k,n−k+1) must satisfy
e+2t<n−k+1 Eq.(1-1)

If Eq.(1-1) is satisfied, the errors (including the erasure error) of the Reed-Solomon code can be completely corrected; if not satisfied, the errors can not be completely corrected. Since the Reed-Solomon code of Part A is RS(6,3,4), an erasure error and an error, or three erasure errors are allowed. The allowable numbers of erasure errors and errors for Part B can also be calculated in this manner.

If the numbers of erasure errors and errors of Part A and Part B satisfy Eq.(1-1), it means that the errors of the pre-pit data can be completely corrected. Thus, the detecting unit 43 still determines the pre-pit data as non-defective. If the numbers of erasure errors and errors of any one of Part A and Part B does not satisfy Eq.(1-1), then the errors of the pre-pit data can not be completely corrected, and the detecting unit 43 determines the pre-pit data as defective.

Further, the detecting unit 43 records into the storage unit 41 whether the pre-pit data is defective, and then the optical drive can use this record to determine whether to access the data block corresponding to the pre-pit data.

In another embodiment, the detecting unit 43 determines a defect level of the pre-pit data according to the syndromes mentioned above. If the syndromes of Part A and Part B are all zero, the pre-pit data is determined as non-defective. If at least one of the syndromes of Part A and Part B is not zero and if the errors of the pre-pit data can be completely corrected, the pre-pit data is determined as low-defective. If the errors of the pre-pit data cannot be completely corrected, the pre-pit data is determined as high-defective. The detecting unit 43 stores the defect level of the pre-pit data into the storage unit 41 for access by the optical drive to determine whether to access the corresponding data block. In one embodiment, when the pre-pit data is non-defective or low-defective, the optical drive determines to access the corresponding data block.

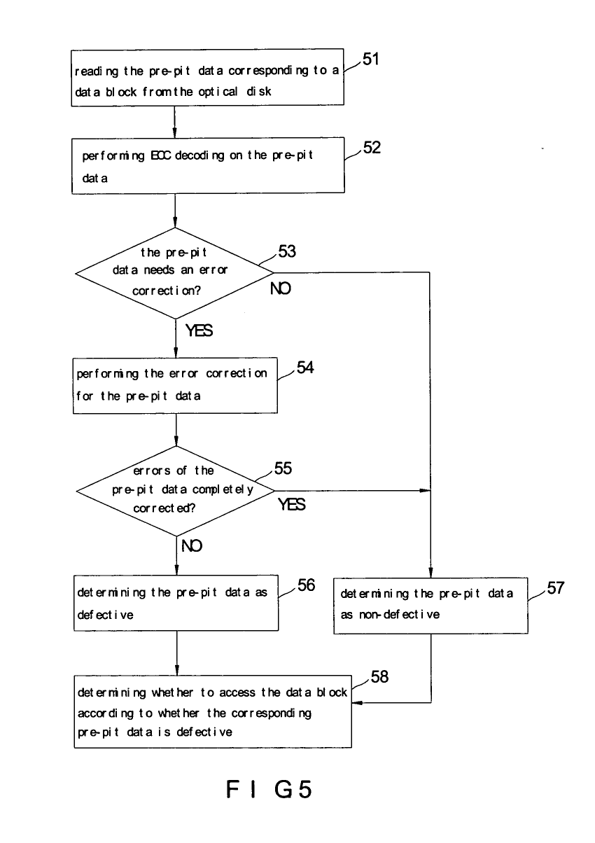

FIG. 5 is a flow chart of a preferred embodiment of the method for defect management of an optical disk according to the present invention. The flow in FIG. 5 includes the following steps:

Step 51: reading the pre-pit data corresponding to a data block from the optical disk;

Step 52: performing ECC decoding on the pre-pit data;

Step 53: determining whether the pre-pit data needs an error correction, if yes then proceeding to Step 54; otherwise jumping to Step 57;

Step 54: performing the error correction for the pre-pit data; (this step 54 can be omitted)

Step 55: determining whether errors of the pre-pit data are completely corrected, if no then proceeding to Step 56; otherwise jumping to Step 57;

Step 56: determining the pre-pit data as defective, and jumping to Step 58;

Step 57: determining the pre-pit data as non-defective; and

Step 58: determining whether to access the data block according to whether the corresponding pre-pit data is defective.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A method for defect management of an optical disk which comprises at least a data block and a corresponding pre-pit data, comprising:
reading the pre-pit data corresponding to the data block from the optical disk;
decoding the pre-pit data to generate a decoded result; and
determining a defect level of the pre-pit data according to the decoded result.

2. The method of claim 1, wherein the optical disk is a DVD disk.

3. The method of claim 1, wherein the decoded result comprises a plurality of syndromes of a first part and a second part of the pre-pit data, and the determining step comprises determining the defect level of the pre-pit data according to the syndromes of the first and second parts.

4. The method of claim 3, wherein when the syndromes of the first and second parts are all zero, the pre-pit data is determined as non-defective.

5. The method of claim 3, wherein when at least one of the syndromes of the first and second parts is not zero, an error correction of the pre-pit data is performed, and the determining step further comprises determining the defect level of the pre-pit data according to a result of the error correction.

6. The method of claim 5, wherein if errors of the pre-pit data are not completely corrected, the pre-pit data is determined as high-defective.

7. The method of claim 5, wherein if errors of the pre-pit data are completely corrected, the pre-pit data is determined as low-defective.

8. The method of claim 1, further comprising:
determining whether to access the data block according to the defect level of the pre-pit data.

9. An apparatus for defect management of an optical disk which comprises at least a data block and a corresponding pre-pit data, comprising:
a storage unit;
a reading unit, coupled to the storage unit, for reading the pre-pit data corresponding to the data block from the optical disk and storing the read pre-pit data into the storage unit; and
a detecting unit, coupled to the storage unit, for decoding the pre-pit data to generate a decoded result and determining a defect level of the pre-pit data according to the decoded result.

10. The apparatus of claim 9, wherein the optical disk is one of DVD-R disk, DVD-RW disk, DVD+R disk, DVD+RW disk, and DVD-RAM disk.

11. The apparatus of claim 9, wherein the decoded result comprises a plurality of syndromes of a first part and a second part of the pre-pit data, and the detecting unit determines the defect level of the pre-pit data according to the syndromes of the first and second parts.

12. The apparatus of claim 11, wherein when the syndromes of the first and second parts are all zero, the detecting unit determines the pre-pit data as non-defective.

13. The apparatus of claim 11, wherein when at least one of the syndromes of the first and second parts is not zero, the detecting unit performs an error correction on the pre-pit data and determines the defect level of the pre-pit data according to a result of the error correction.

14. The apparatus of claim 13, wherein if errors of the pre-pit data are not completely corrected, the detecting unit determines the pre-pit data as high-defective.

15. The apparatus of claim 13, wherein if errors of the pre-pit data are completely corrected, the detecting unit determines the pre-pit data as low-defective.

16. The apparatus of claim 9, wherein an optical drive determines whether to access the data block according to the defect level of the pre-pit data.

17. The apparatus of claim 16, wherein when the defect level of the pre-pit data is non-defective or low-defective, the optical drive determines to access the data block.

18. An optical drive for reading data of an optical disk which comprises at least a data block and a corresponding pre-pit data, comprising:
a defect management apparatus comprising:
a storage unit;
a reading unit, coupled to the storage unit, for reading the pre-pit data corresponding to the data block from the optical disk and storing the read pre-pit data into the storage unit; and
a detecting unit, coupled to the storage unit, for decoding the pre-pit data to generate a decoded result and determining a defect level of the pre-pit data according to the decoded result.

19. The optical drive of claim 18, wherein the optical drive determines whether to access the data block according to the defect level of the pre-pit data.

20. The optical drive of claim 18, wherein the decoded result comprises a plurality of syndromes of a first part and a second part of the pre-pit data, and the detecting unit determines the defect level of the pre-pit data according to the syndromes of the first and second parts.
